(19) United States
(12) Patent Application Publication
(10) Pub. No.: US 2002/0167529 A1
(43) Pub. Date: Nov. 14, 2002

(54) Computer system for displaying object images

(76) Inventor: Shao-Tsu Kung, Taipei (TW)

Correspondence Address: NAIPO (NORTH AMERICA INTERNATIONAL PATENT OFFICE), P.O. BOX 506, MERRIFIELD, VA, 22116, US

(21) Appl. No.: 09/851,572

(22) Filed: May 10, 2001

(51) Int. Cl. G09G 5/02

(52) U.S. Cl. 345/600

(57) ABSTRACT

A computer system for displaying object images includes a memory for storing programs and data, a processor electrically connected to the memory for executing the programs in the memory, and a display device electrically connected to the processor for displaying a picture image. The picture image has a plurality of object images. A user can select at least an object image in the picture image and trigger a zoom key to zoom in or zoom out only the selected object image on the display device.

### BACKGROUND OF THE INVENTION

1. Field of the Invention

The present invention relates to a computer system, and more particularly, to a computer system that can provide a method to enlarge a particular object image in a picture image without necessarily enlarging the entire picture.

2. Description of the Prior Art

In general, a picture image comprises a plurality of object images. Each object image stands for an application program, a directory, a file, or a meaningful block. If the picture image includes many object images, such that a particular object image on screen is too small for a user to view clearly, the user can usually enlarge the entire picture image, and then scroll the enlarged picture image to look for a particular object image. But, it can be difficult for him to look for the particular object image if the picture image is complex and the user is not familiar with the picture.

Please refer to FIG. 1, FIG. 2 and FIG. 3. FIG. 1 is a perspective view of a computer system 10 according to the prior art, FIG. 2 is a perspective view of a picture image 46 in the computer system 10, and FIG. 3 is a perspective view of the picture image 46 when enlarged. As shown in FIG. 1, the computer system 10 comprises a memory 20 for storing a program 22 and data 24, a CPU 30 which is electrically connected to the memory 20 for executing the program 22, and a display device 40 which is electrically connected to the CPU 30. The display device 40 comprises a screen 42 for displaying a picture, e.g. the picture image 46 that includes a plurality of object images 44.

As shown in FIG. 2 and FIG. 3, the picture image 46 in the computer system 10 includes a plurality of object images 44. To view the object image F clearly, a user can enlarge the picture 46, and then scroll the enlarged picture 46 to look for the particular object image F. To view another object image I, the user must scroll the enlarged picture 46 again, then look for the object image I in the enlarged picture 46. If the user wants to look at both object images F and I at the same time, the user will be busy looking for these two objects in the picture 46 by scrolling the picture 46. To the user, this is not convenient.

### SUMMARY OF THE INVENTION

It is therefore an objective of the present invention to provide a computer system that can provide a method to enlarge a particular object image in a picture image without necessarily enlarging the entire picture image in the computer.

According to the claimed invention, the computer system for displaying object images comprises a computer system and a method of zooming an object image in the computer system. The computer system further comprises a memory for storing programs and data, a processor electrically connected to the memory for executing the programs in the memory, and a display device electrically connected to the processor for displaying a picture image. The picture image has a plurality of object images. A user can select at least an object image in the picture image and trigger a zoom key to zoom in or zoom out only the selected object image on the display device.

The method of zooming an object image in a computer system comprises the following steps:

(a) Select at least one object image from the picture image,

(b) Trigger a zoom key so as to zoom in or zoom out only the selected object image,

(c) Trigger the zoom key again to restore the selected object image to original size after performing step (b), or, set a display ratio of the selected object image after the zoom key is triggered,

(d) Use a pointing device to move the cursor on the display device to select the object image, and

(e) Drag the selected object image to different positions on the display device.

It is an advantage of the present invention that the present invention can provide a computer system that is able to provide a method to enlarge a particular object image in a picture image without necessarily enlarging the entire picture image.

These and other objectives and advantages of the present invention will no doubt become obvious to those of ordinary skill in the art after reading the following detailed description of the preferred embodiment which is illustrated in the various figures and drawings.

### BRIEF DESCRIPTION OF THE DRAWINGS

FIG. 1 is a perspective view of a prior art computer system.

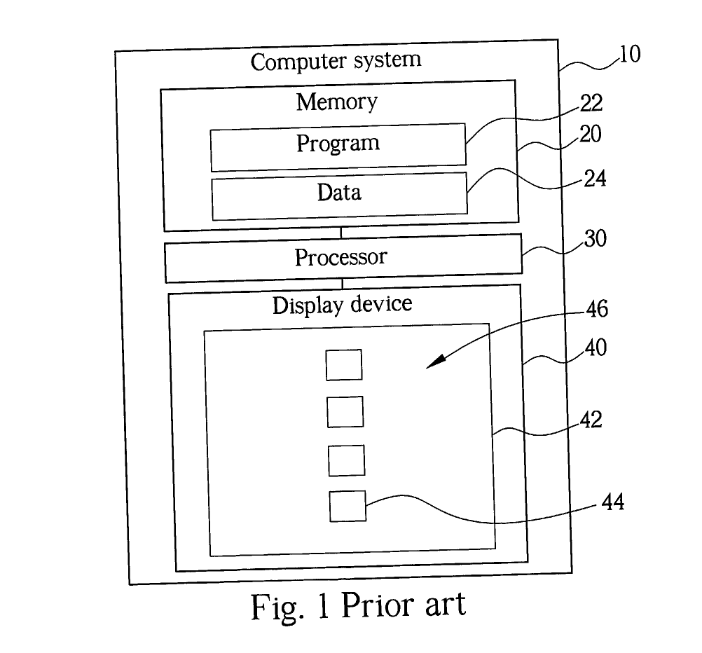

FIG. 2 is a perspective view of a picture image in the computer system in FIG. 1.

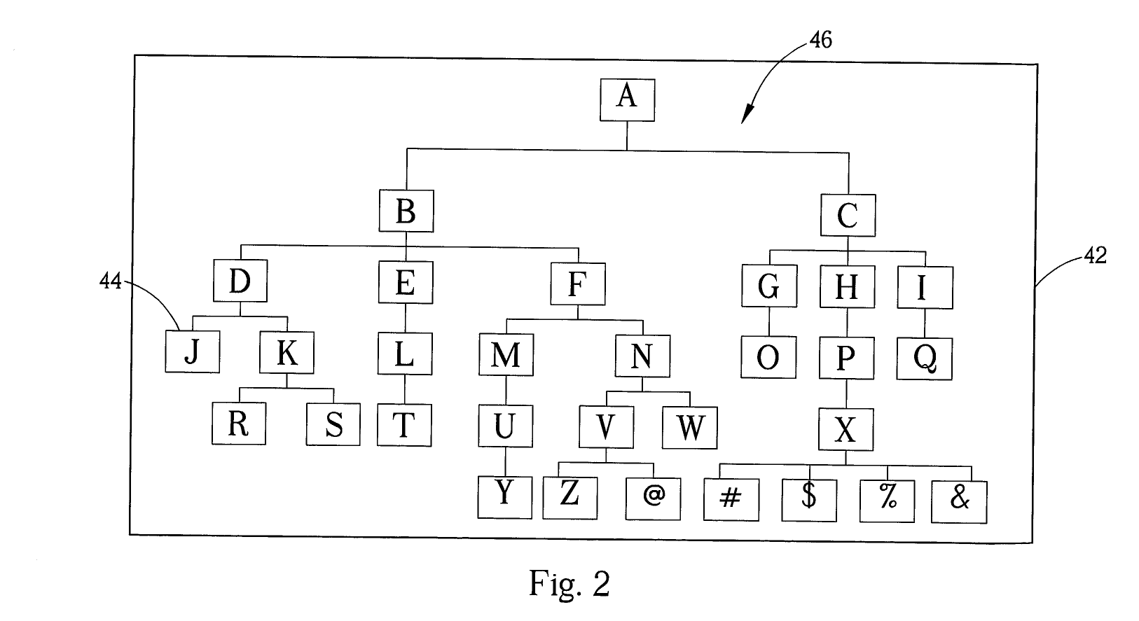

FIG. 3 is a perspective view of the enlarged picture image of FIG. 2.

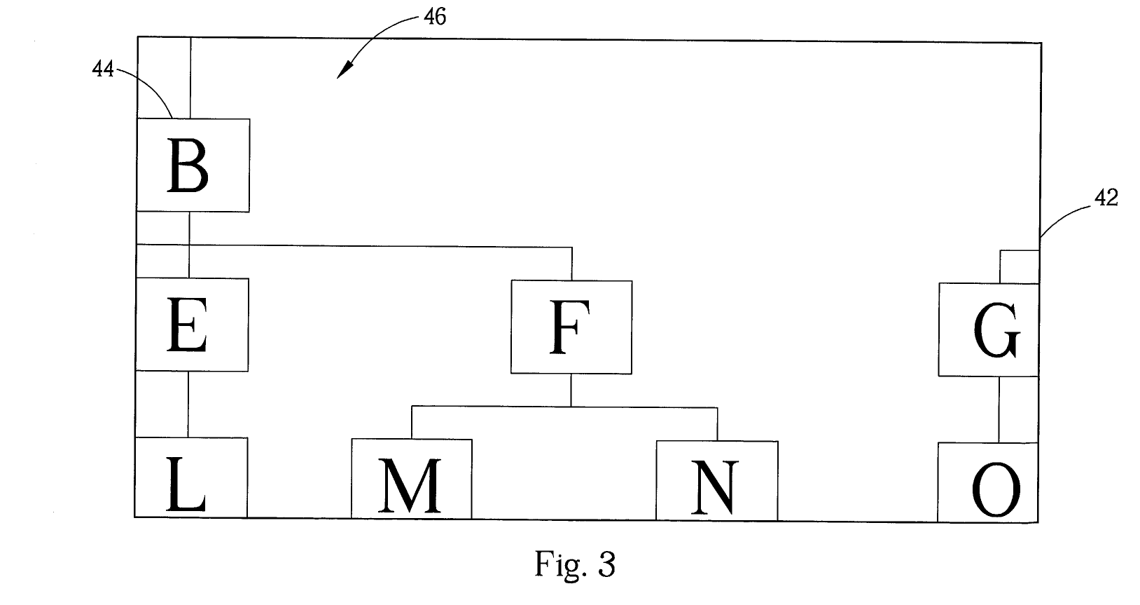

FIG. 4 is a perspective view of a computer system according to the present invention.

FIG. 5 is a perspective view of a picture image in the computer system of FIG. 4.

FIG. 6 is a perspective view of the picture image shown in FIG. 5, in which an object image F is enlarged.

FIG. 7 is a perspective view of the picture image shown in FIG. 5 in which object images F and I are enlarged at the same time.

FIG. 8 is a perspective view of the picture image shown in FIG. 5 in which object images F, I, and Q are enlarged at the same time.

FIG. 9 is a perspective view of the picture image shown in FIG. 5 in which the enlarged object images I and Q are distinguished.

### DETAILED DESCRIPTION OF THE PREFERRED EMBODIMENT

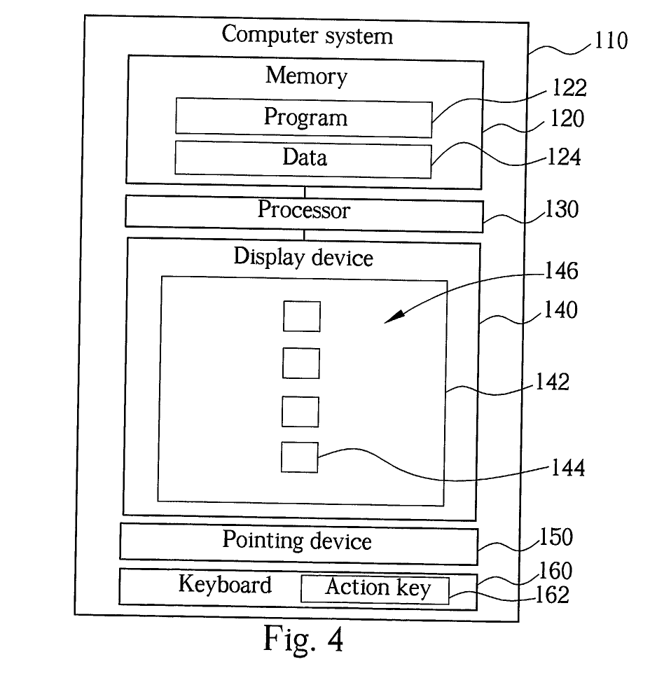

Please refer to FIG. 4. FIG. 4 is a perspective view of a computer system 110 according to the present invention. The computer system 110 comprises a memory 120 for storing a program 122 and data 124, a CPU 130 for executing the program 122, and a display device 140 which is electrically connected to the CPU 130. The display device 140 comprises a screen 142 for displaying a picture image 146 that includes a plurality of object images 144.

The computer system 110 further comprises a pointing device 150 or a keyboard 160 that is electrically connected to the CPU 130. A user can use the pointing device 150 to move the cursor in the display device 140 or use the directional keys of the keyboard to select a particular object image 144 in the picture 146. Then, the pointing device 150 or the action keys 162 can be triggered to perform an action on the selected object image 144.

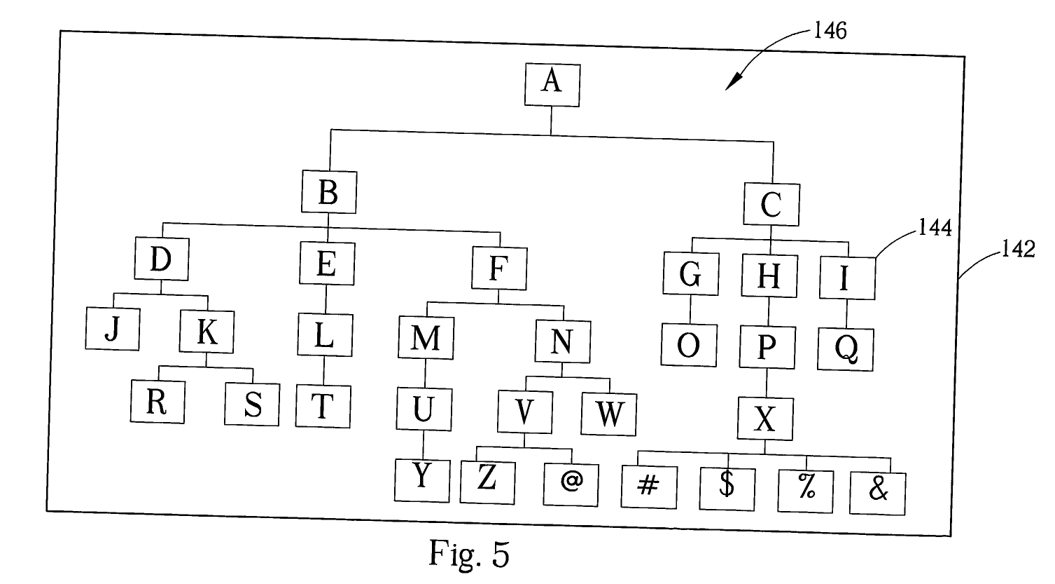

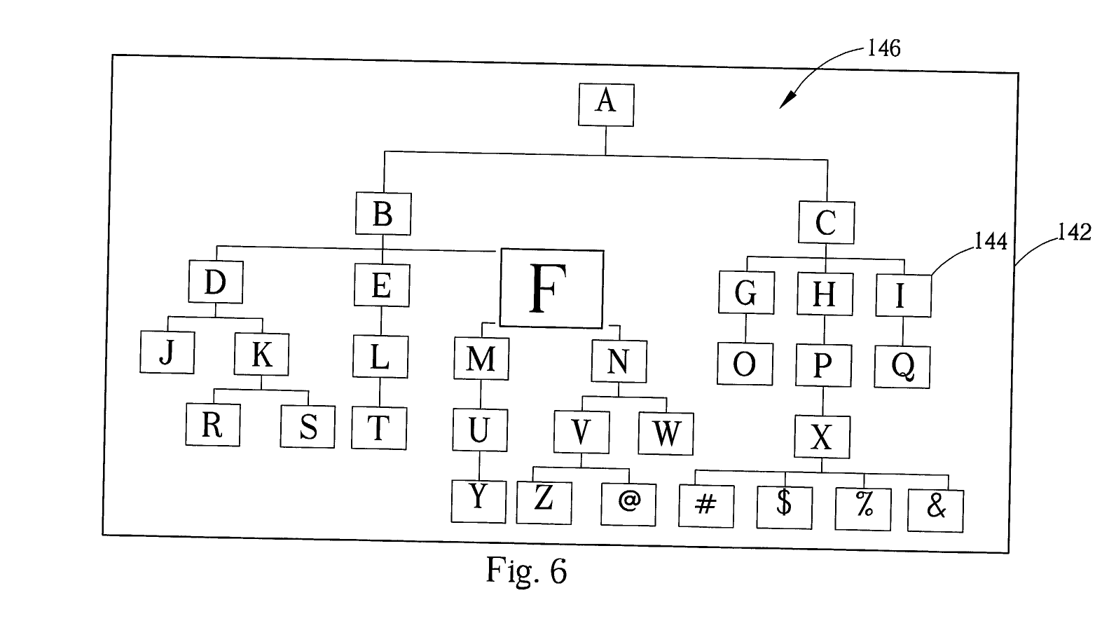

Please refer to FIGS. 5-9. FIG. 5 is a perspective view of the picture image 146 in the computer system 110. FIG. 6 to FIG. 9 are perspective views of the picture image 146 with some enlarged object images 144. As shown in FIG. 6, a user can select an object image F in the picture image 146 and act on the object image F to enlarge it by triggering the action keys 162. If the action key 162 is triggered one more time, the enlarged image F will be restored to an original size, as shown in FIG. 5.

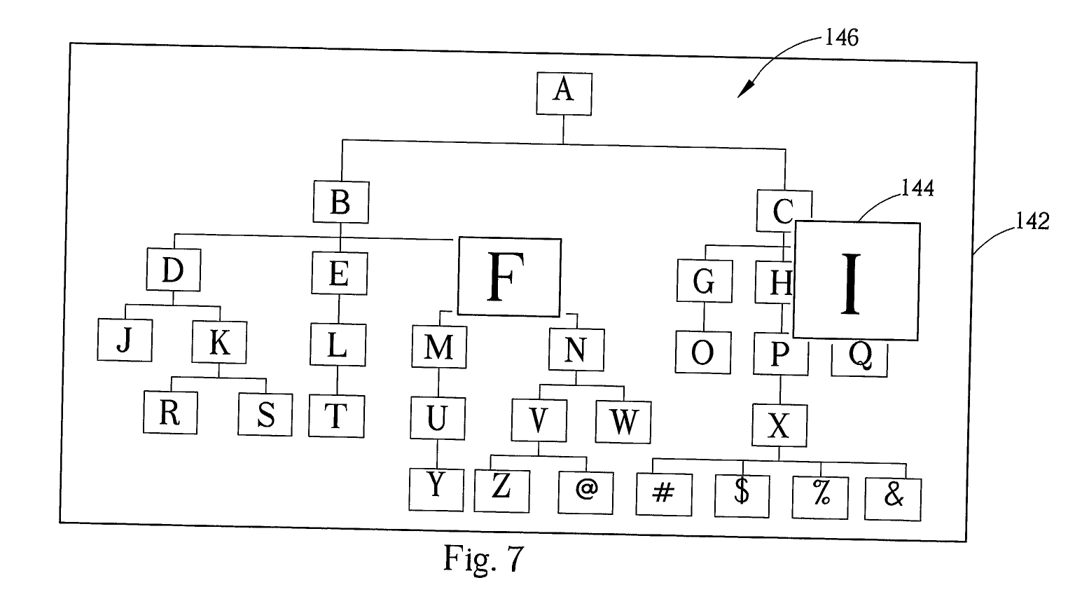

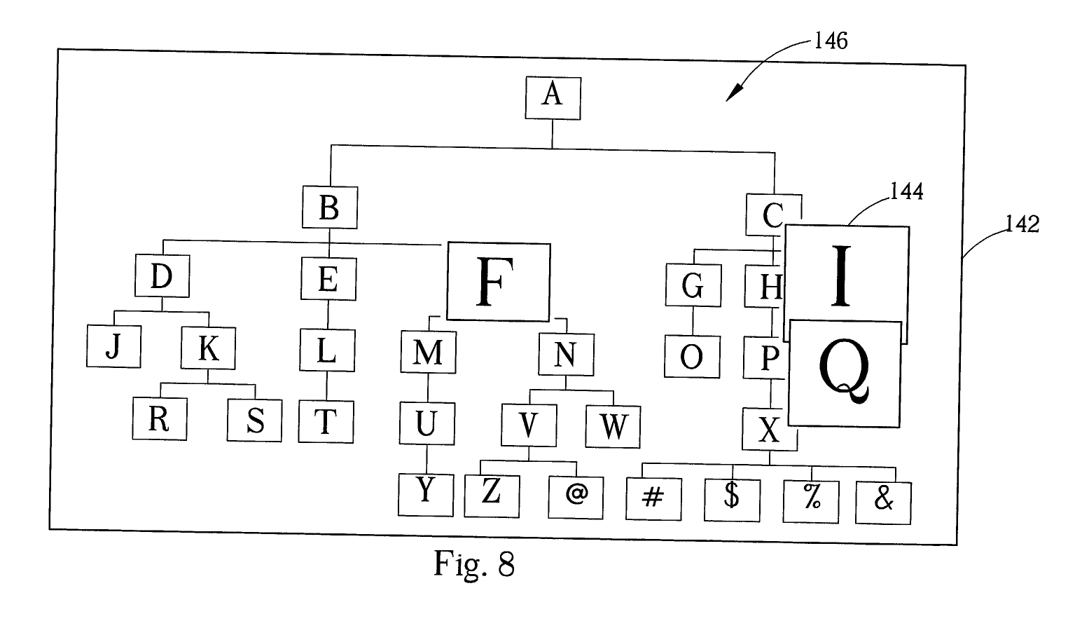

Using the same operations, a user can arbitrarily select more than one object image and enlarge the object images to have the same, or differing, display ratios. As shown in FIG. 7 and FIG. 8, the object images F, I, and Q are enlarged to different display ratios.

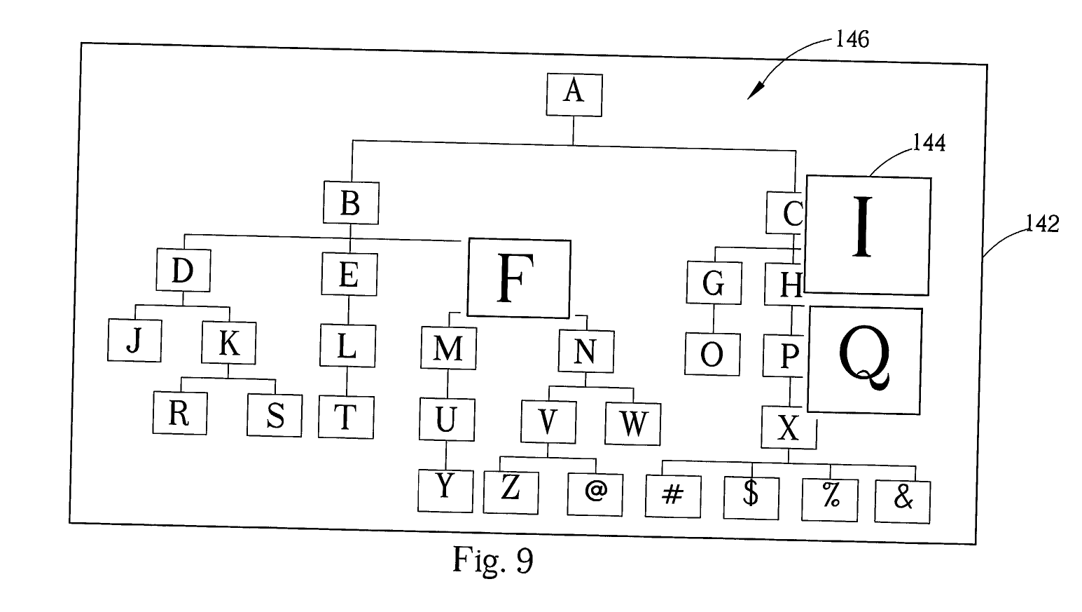

Please refer to FIG. 8. The object image Q overlaps the object image I after they have been enlarged. Some contents in the object image I are covered by the object image Q. The present invention provides another function that can separate and distinguish these overlapped object images. As shown in FIG. 9, the object images I and Q are separated through a drag action.

In the computer system 110, the object images 144 can be enlarged to different display ratios by the following steps:

(a) Move the cursor of display device 140 by using the pointing device 150 or directional keys on keyboard 160 to select the object image F,

(b) Act on the object image F by triggering the action key 162.

(c) Enlarge the object image F to a desired display ratio by triggering the action key 162,

(d) Move the cursor of display device 140 by using the pointing device 150 or directional keys on keyboard 160 to select the object image I,

(e) Act on the object image I by triggering the action key 162.

(f) Enlarge the object image I to another desired display ratio by triggering the action key 162,

(g) Move the cursor of display device 140 by using the pointing device 150 or directional keys on keyboard 160 to select the object image Q,

(h) Act on the object image Q by triggering the action key 162.

(i) Enlarge the object image Q to another desired display ratio by triggering the action key 162, and

(j) Separate the object images I and Q by dragging them to proper positions on the screen.

For restoring the object images F, I, Q to the original size, follow steps:

(k) Move the cursor of display device 140 by using the pointing device 150 or directional keys on keyboard 160 to select the object image F,

(l) Restore the object image F to its original size by triggering the action key 162,

(m) Move the cursor of display device 140 by using the pointing device 150 or directional keys on keyboard 160 to select the object image I,

(n) Restore the object image I to its original size by triggering the action key 162,

(o) Move the cursor of display device 140 by using the pointing device 150 or directional keys on keyboard 160 to select the object image Q, and

(p) Restore the object image Q to its original size by triggering the action key 162.

In contrast to the prior art 10, the present invention can provide a computer system 110 that is able to provide a method to enlarge a particular object image in a picture image instead of enlarging the entire picture image for looking at the particular object image. So, a user need not scroll through the enlarged picture 146 to look for the particular object image.

Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A computer system comprising:
a memory for storing programs and data;
a processor electrically connected to the memory for executing the programs in the memory; and
a display device electrically connected to the processor for displaying a picture image, the picture image having a plurality of object images;
wherein a user can select at least an object image in the picture image and trigger a zoom key to zoom in or zoom out only the selected object image on the display device.

2. The computer system of claim 1 wherein the selected object image is restored to original size when the zoom key is triggered again.

3. The computer system of claim 1 wherein the user is capable of setting a display ratio of the selected object image after the zoom key is triggered.

4. The computer system of claim 1 further comprising a pointing device electrically connected to the processor for moving a cursor on the display device so as to move the cursor to the object image.

5. The computer system of claim 1 further comprising a keyboard electrically connected to the processor wherein the user is capable of using directional keys on the keyboard to select the object image.

6. The computer system of claim 1 wherein the user is capable of dragging the selected object image to different positions on the display device.

7. A method of zooming an object image in a computer system, the computer system comprising a memory for storing programs and data, a processor electrically connected to the memory for executing the programs in the memory, and a display device electrically connected to the processor for displaying a picture image, the picture image having a plurality of object images, the method comprising:
(a) selecting at least one object image from the picture image;
(b) triggering a zoom key so as to zoom in or zoom out only the selected object image.

8. The method of claim 7 further comprising:
(c) triggering the zoom key again to restore the selected object image to original size after performing step (b).

9. The method of claim 7 further comprising:
(d) setting a display ratio of the selected object image after the zoom key is triggered.

10. The method of claim 7 wherein the computer system further comprises a pointing device electrically connected to the processor, the method further comprising:
(e) using the pointing device to move the cursor on the display device to select the object image.

11. The method of claim 7 wherein the computer system further comprises a keyboard electrically connected to the processor, the method further comprising:
(f) using directional keys on the keyboard to select the object image.

12. The method of claim 7 further comprising:
(g) dragging the selected object image to different positions on the display device.
